(19) United States
(12) Patent Application Publication
(10) Pub. No.: US 2006/0188535 A1
(43) Pub. Date: Aug. 24, 2006

(54) Method of controlling aquatic insects

(76) Inventors: Robert D. Sjogren, Ladera Ranch, CA (US); David R. Sjogren, Sherwood, OR (US)

Correspondence Address: MERCHANT & GOULD PC, P.O. BOX 2903, MINNEAPOLIS, MN, 55402-0903, US

(21) Appl. No.: 11/064,074

(22) Filed: Feb. 23, 2005

(51) Int. Cl. A01N 25/00

(52) U.S. Cl. 424/405

(57) ABSTRACT

The control of aquatic insects can be accomplished by the careful application of an insect control unit into a treatment site in a treatment locus. A careful application of a defined amount of pest control in a pest control unit can effectively control flying insects emerging from aquatic environments with reduced use of control agents and reduced environmental impact.

### FIELD OF THE INVENTION

The invention relates to the control of insect pests that emerge from aquatic locations where the pests hatch, mature and subsequently enter the terrestrial environment. The invention is a flexible treatment that can achieve substantial insect control for a desired period in an entire treatment locus. In the process of the invention, the careful placement of a control unit or units, on or at a defined treatment site within a treatment locus can achieve the required degree of control for the time required in the entire locus. Each control unit has a carefully defined amount of control material. The carefully calculated and defined amount of control material in a control unit combined with the careful placement of the control unit in a calculated area of a treatment site within a treatment locus results in excellent insect control with minimal environmental impact.

### BACKGROUND OF THE INVENTION

In many areas of United States and around the world, insect pests can cause health problems or can be a substantial nuisance in the outdoor environment. Flying insects such as flies, mosquitoes and other flying pests can be a unique, recurrent nuisance, can cause itchy or painful bites or can cause the spread of disease such as West Nile Virus, equine encephalitis and other more serious diseases in Third World countries. Many such pests develop in, mature and are released from aquatic environments. For example, mosquito populations, depending on availability of breeding locations, the degree of manmade run-off or rainfall, temperature and other environmental variables, can arise in urban and rural environments. The life span of most flying insects is not substantial, however, after emergence and mating, pestiferous insect eggs are again laid in breeding sites and can hatch episodically. The resulting larvae and other immature forms can continue to mature throughout the year into adult stages resulting in a continuing resupply of pestiferous flying insect populations. Attempts to control populations have been tried using a variety of insect control agents, formulations and techniques. Such techniques have been directed to the breeding and maturation locus, the likely environmental niche of the flying insect and directed towards the habitat of human populations suffering from the presence of the insects.

In the prior art, the treatment of aquatic breeding sites or loci requires the careful application of a control agent to the aqueous environment. A variety of aqueous control agents have been created. Sjogren, U.S. Pat. Nos. 4,732,762, 4,971,796 and 5,484,600 disclose a briquette, granular or particulate form of a pest control agent. The briquette form of the pest control agent comprises a cast plaster briquette of defined hardness that can slow the release of the pest control agent into the aqueous environment. The briquette can contain the agent in combination with a number of ingredients to stabilize the agent and to control release. The granular form comprises a core, a coating and the pest control agent. Such a granular form can be distributed to the general environment including aquatic and dry aquatic sites. Levy, U.S. Pat. No. 5,858,386 and Levy, U.S. Pat. No. 6,512,012 teaches enhancing the action of conventional pest agents with a designed formulation using surface film resulting from the application of the agent.

The Metropolitan Mosquito Control District of Minnesota has used a briquette form of the mosquito control agent and has licensed the technology to Wellmark International to sell Altosid XR® Briquets to other governmental agencies in the United States and elsewhere.

In large part, all of these patents relate to the continuous, generally uniform broadcast application, over the substantial entity of an aquatic surface using briquette, pellet, powder, spray or other material at a rate of anywhere from about 2.5 to 20 pounds of treatment material per acre. The briquette, for example, can be selectively placed in an aquatic site for mosquito control. The patent suggests the application of a briquette in carefully placed locations across the treatment site. The briquette is designed to be used for floodwater mosquito control by uniformly placing about one briquette per each 200 square feet (about 6 m²) of aquatic location at a treatment rate of about 200 to 400 grams of methoprene per acre or 8000 m² (about 0.02 to 0.05 gms-m⁻²) of aqueous site.

We have found that a substantial need exists for a flexible treatment method that can obtain a substantial degree of control over a large area for a desired period when applied to a single treatment locus.

### SUMMARY OF THE INVENTION

The invention comprises a method of obtaining an extended degree of control of flying insects that develop in an aquatic environment in a treatment locus. The treatment site is a selected portion of a treatment locus, while the locus is understood to be the entire site that is aquatic or episodically aquatic. We have found that pest control can be obtained in either an entire wet aqueous site or in a site that is flooded periodically and requires control only when wet (up to 8,000 or as much as 16,000 m²).

The minimum treatment amount for control that can last for 1 to 14 days involves a method of treating the locus with at least 3 grams of active agent per acre. For short-term treatment, the amounts can range from at least 4.4 grams per acre or for treatment that is initially effective and has some residual effect for up to three weeks, an amount of at least 6.0 grams per acre can be used. For true residual activity, an amount of at least 250 grams per acre are used, or for difficult to treat sites, an amount of from at least 400 grams per acre can be used.

Any pest-producing locus can be selected for treatment as long as it contains contiguous water for a time sufficient for pest maturation during the pest season. Typically, some loci are flooded for a short time and are active in pest generation only when wet. Such temporarily flooded sites are effectively treated as a whole by a careful placement of the treatment to the site when dry. As the soluble/dispersible envelope or matrix interacts with water, the particulate and control material formed within the unit can be then released as the envelope or matrices dissolve. The natural tendency of the release material is to spread, over time (usually about 1 to 10 hours), across the entirety of the treatment site, releasing the control material. The control unit is engineered such that as sufficient particulate and control material is released, the particulates spread across the entire treatment site and begins to release the control material. The careful placement of the control unit into defined locations within the control site ensures that the control unit is strategically placed within the treatment locus such that the entire locus obtains sufficient control material to prevent the hatching, maturation, growth, etc. of the aquatic pest. Depending on the amount of control material held within the control unit, one or more of the control units are placed in the treatment site such that the total amount of control material supplied by the unit or units is sufficient to treat the entire locus.

The control unit envelope material can be a water soluble or dispersible envelope. The term “envelope” means a generally flexible container that surrounds, contains or restrains the particulate, the active agent and other components. The envelope can be made from a polymeric sheet or a woven or non-woven fabric. The primary requirement of the envelope material is that it is water soluble or dispersible within a short period after application. The material should be sufficiently water sensitive such that the contents of the envelope is released into the environment within a relatively short period of time, i.e., substantially less than 6 hours, less than about 2 hours, typically less than about 1 hour. The “matrix” is typically a single solid unit with the control material dispersed throughout the unit. The term “control material” will include any substance or blends of substances that can inhibit growth, inhibit maturation or kill a pest. The term “control unit” will be any unitary form containing pest control material within an envelope or in a “matrix”. The term “control material” is an agent such as methoprene or blends of methoprene with other control materials or inert components. The term “treatment site” is an area for treatment within the 500-8000 m² portion of the locus. The term “treatment zone” includes an area, about 1 to 200 m² or 1 to 50 m² of a “treatment site” and includes a number of defined locations for potential treatment with the control agent in a control unit. For example a treatment locus typically includes the entirety of a pond, wetland, slough, bayou, lake, or other body of water that can support and result in substantial aquatic insect production. The “treatment site” is a fraction of the area of the treatment locus. The “defined location” is the specific location of placement of the “control unit” in the treatment zone. The term “obtaining a measure of the surface area” refers to any measurement or estimate of the surface area of a locus that is accurate to ±25% of the area.

In the use of the control unit of the invention, the treatment of the entire treatment area with a defined amount of the treatment control agent in a treatment unit in a carefully placed method can result in insect control throughout the treatment locus. The primary requirements for the treatment unit of the invention comprise a soluble or dispersible envelope or matrix containing the treatment agent plus a particulate material. Optionally, the treatment unit can also contain a material that acts as a floatation material or as a material that causes the treatment composition to sink. The floatation material can have a density less than 1 while the sinkable material can have a density greater than 1. In certain instances, the particulate can act both as a carrier of the active agent and as a floatable or sinkable material.

### BRIEF DESCRIPTION OF THE INVENTION

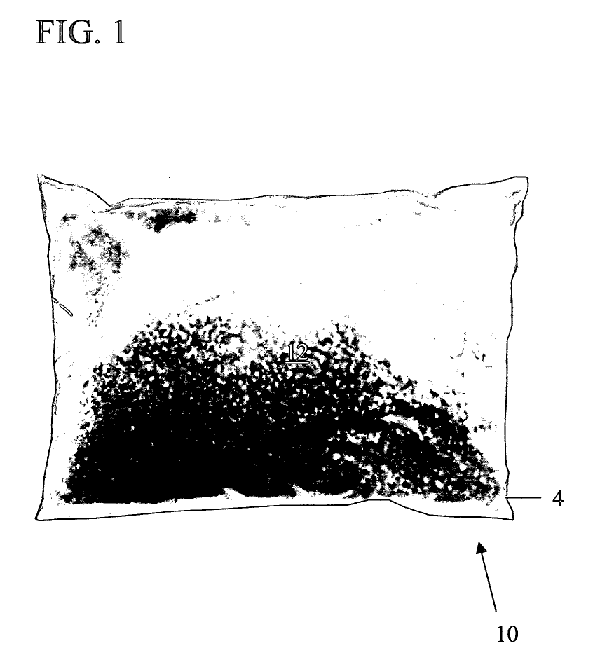

FIG. 1 is a plan view of the treatment unit of the invention comprising a water-soluble envelope containing the active agent absorbed onto a particulate carrier.

### DETAILED DESCRIPTION OF THE PREFERRED EMBODIMENT

The method of the invention involves carefully placing a control unit in a treatment site within the treatment locus. The control unit typically comprises a control agent combined with a solid support such as a particulate, diluent or carrier, containing the treatment agent at a treatment rate designed for the predetermined duration in a locus of a known size. Control can be obtained for a limited period or up to an entire pest-breeding season. The control agent and particulate are typically blended and packaged within a soluble film or in a soluble or dispersible matrix. The control unit can be sized and configured such that it can treat a treatment locus by placing one or more control units in a treatment site. As the soluble or dispersible envelope or soluble or dispersible matrix interacts with water, the particulate, diluent or carrier and control agent is released into the treatment locus. The material naturally spreads across the surface of the locus effecting control of insect emergence. The control agent combined with a particulate having a density less than 1 tends to reside on the surface for an extended period of time dispersing throughout the site. As the control agent and particulate absorb water, the agent and particulate can sink to the bottom of the locus, but can still continue to release the water-soluble control agent, which typically distributes itself throughout the locus. The use of a particulate having a density greater than 1 tends to sink to the bottom upon dispersion or dissolution of the control unit, but can continue to release control agent into the locus. Such a treatment can still release sufficient control agent into the locus for emergent insect control. The method can be tailored to small loci, about 50 to 500 m², to larger loci, about 500-2000 m², to even larger loci, about 2000-4000 m², about 4000-8000 m² and to loci as large as 4000-16,000 m². We have found a method of controlling pests in a locus of up to about 8000 m², or more, that can achieve extended or residual control by applying a predetermined amount of active control agent in one or more units. We have developed a treatment unit that can be used in these improved methods. The unit uses the properties of the material to obtain control that can extend to the limits of the locus and inhibit pest emergence. In certain loci a single treatment site can be established that can effectively treat the entire locus. The methods are flexible and can be used to easily treat an entire locus at a time chosen by the user. We have found that the treatment of the locus within a single arbitrarily selected treatment site can achieve full treatment of the locus. The method comprises selecting an aquatic environment treatment locus, obtaining the surface area of the aquatic environment and defining one or more treatment sites.

Some treatment loci are small enough such that they comprise single treatment sites. Such loci are typically up to about 500 m², about 500 to 1000 m² about 1000 to 2000 ml about 2000 to 4000 m² about 4000 to 8000 m² or often as large as 16,000 m². Commonly, a single treatment unit can be used to treat a locus of about 500 to 8000 m². Any treatment locus is in excess of 4000 m² it can be conveniently divided into one or more treatment sites. One value of the control unit of the invention is that the control unit can be placed entirely on a single defined site within the treatment locus, but still obtain successful pest control throughout the locus without careful broadcast of the pesticidal treatment units substantially uniformly across the treatment locus.

Within the treatment locus, control is obtained for a predetermined time by distributing at least one of the insect control units per each 50 to 8000 m² locus into a defined treatment site. Into the treatment site is placed about 6 to 500, or 12 to 150 grams of a mosquito control active agent (disregarding inert materials and packaging) per 8000 m 2. For a defined period of about 2 weeks about 0.001 to 0.003 grams/m⁻² is used, for a defined period of about 4 weeks about 0.002 to 0.02 grams/m⁻² is used, for a defined period of about 8 weeks about 0.004 to 0.04 grams/m⁻² is used, to obtain residual control for a defined period commensurate with a breeding season, about 0.03 to 0.2 grams/m⁻² is used.

The invention also comprises a treatment unit comprising a water soluble or dispersible envelope or matrix containing a predetermined amount of the active control material and a particulate diluent or other inert carrier designed for control over a predetermined area for a predetermined duration. The contents of the treatment unit contain a sufficient and an effective treatment amount of the control material and a solid support in the form of a particulate, diluent or carrier. The solid support can have a density less than 1.

The control material and the low-density particulate are released by the dissolution of the soluble/dispersible envelope or matrix. The particulate spreads substantially over the treatment site and begins to release the control material into the water and thence by Brownian movement through out the locus regardless of placement. As a result the desired degree of control can be obtained throughout the locus by placing the treatment unit at a site in the locus. Certain particulate materials can absorb water and then sink to the bottom of the treatment site, but can continue to release over the entire area of the treatment site regardless of placement. The control unit is sized (with sufficient weight and size dimensions) and configured to promote easy manual application of the control unit to a defined treatment location within the treatment site. In other words, the treatment unit has sufficient mass (10 to 1000 grams, 30 to 300 grams) to be easily manually thrown into a site. The unit also is designed to have a size, e.g., length, width and depth, for manual or mechanical distribution by an individual. No dimension of the unit is greater than 25 cm. Once the treatment locus has been inspected, divided into treatment sites, one or more of the control unit can be accurately placed into each treatment site.

The control agent useful in the invention includes any compound or composition that can be used to control unwanted aqueous insects such as flies, midges, mosquitoes, etc. In general, exemplary pest control materials include active agents that are sparingly soluble. Such materials have a solubility of 0.01 to 5 ppm in environmental water.

The control unit of the invention typically comprises a control material and a particulate. A preferred particulate for use in the treatment unit of the invention comprises perlite. Perlite is a mineral typically characterized as a potassium aluminosilicate derived from volcanic activity. Perlite is a glassy material that expands and becomes porous when heated. When heated, it can expand to as much as 20 times its original value and is dry and has substantial surface area. The expansion, upon heating, is the result of the volatilization of water contained in the original perlite lava rock. Typically, the material is heated to greater than 800° C. The water trapped in the rock turns to vapor causing the rock to expand substantially. Once heated, perlite is typically light gray to white. Crude perlite is the material obtained directly from nature containing 2 to 5 wt % water. Virtually, any particulate material having an absorbent capacity that has a density less than water can be used. Examples of the carrier material that can be used in this application include perlite, sawdust, paper pulp and cotton fluff. Once processed, heated and expanded, the perlite forms the low density, high surface area material well known. Other materials including diatomaceous earth, pumice, expanded clays and expanded shales can be used in place of the perlite, however, perlite is desirable in light of its dryness, surface area and cost.

A preferred particulate has a density less than 1. A higher density particulate can cause the control agent to sink to the bottom of the locus. The low density of the particulate material ensures that the particulate will initially float on the surface of the aqueous site to be controlled until the material naturally spreads across the treatment site. The particle size and nature of the particulate is selected such that the particulate spreads across the treatment site until the entire treatment site has at least some amount of active control material. Once effectively spread across a treatment site, the particulate can then absorb a sufficient amount of water such that the particulate will then slowly sink to the bottom of the locale. However, even after sinking, the particulate can continue to release the control agent into the aqueous environment.

The control unit can be combined with a solid support before forming the control unit is the form of an envelope or solid matrix. The control agent, liquid or solid can be made and used in substantially 100% active form in the form of a concentrate or composition comprising a relatively large proportion of the control material with a liquid or solid diluent. Typically, the control agent is used with a particulate. Often such control materials are packaged as a mixture of the control material, an optional liquid or solid diluent substance and particulate. Such diluted compositions can be liquid or solid and can contain about 0.2 to about 30% of the control material and about 70 to 99% of a diluent material. Liquid diluents include water, lower alcohols, PEG materials, hydrocarbons, liquid polymers, etc. Solid diluents include commonly available absorbents containing the control material and can be provided as a finely divided particulate, an aqueous dispersion or an aqueous solution. Once combined with the solids, the resulting material can be dried before placement into the form of the treatment unit.

No list of useful pesticide can be complete since there are new pesticides created that may be useful in this invention. However, any pesticide having insect control properties, which can be compatible with a carrier particulate and an absorbent, can be used in the invention. The pesticides which are preferred for use in the invention are materials including isopropyl-(2E,4E,7S)-11-methoxy-3,7,11-trimethyl-2,4-dodecadienoate, which is the active ingredient in the composition, available under the trade name Altosid® from Wellmark International, an insect specific growth regulator that acts to prevent the emergence of adult mosquitoes and small flies from the pupae stage by affecting only the maturation process and is not a nondiscriminant toxin.

The envelope, apart from the agent and solid support, can additionally contain an absorbent material with a relatively high surface area. In the design of the treatment object of the invention, the absorbent material tends to create a controlled release substance by absorbing and releasing the active ingredient at a controlled rate. The absorbent material typically comprises a finely divided powder having a particle size that ranges from about 5 to about 35 microns having a surface area that ranges from about 900 to about 1,200 square meters/gram. The small particle size and large surface area creates a material that is effective in controlled release of the active substance once the envelope dissolves or disperses and the carrier active ingredient and controlled release particulate is caused to enter into the environment. Preferred absorbents include activated carbon, silica, zeolite and similar materials.

The envelope can be made from water soluble polymeric materials including polymers such as partially hydrolyzed polyvinyl alcohols, polyvinyl pyrrolidones, cellulosic derivatives such as hydroxy propyl cellulose, hydroxy methylcellulose, and general cellulosic polymers bonded into a non-woven fabric. Further, the envelope can be made by binding a relatively insoluble fiber with soluble binder resins into a woven or non-woven material that can disperse in the aqueous treatment site. The envelope can be made in virtually any shape. The envelope can be a two-layer unit having a square, round, rectangular or triangular aspect. Further, the envelope can be an article made by overlapping a single piece of envelope material and securing the overlapped edges. Further, the envelope can be made in the form of a flexible cylinder, cube or any other convenient geometrical shape. The envelope typically has an enclosed volume that ranges from about 25 mL to as large as 1 liter. Commonly, the enclosed volume of the envelope will range from 60 mL to 300 mL.

Typically, the envelope described above contains up to about 250 grams of the carrier having a density less than water, about 0.3 to 750.0 grams of the absorbing powder and up to about 500 grams of the control agent depending on the area of the locus and needed duration of control. In the article of the invention, the pesticide can be included entirely on the low-density absorbent material, on the low-density carrier material, the absorbent material, or both, in the manufacture of the article of the invention.

The control unit in the form of a solid matrix can comprise a water soluble or dispersible matrix containing the active control agent and the particulate. In the control matrix, the matrix material is there as a soluble matrix or binder maintaining the unit in a solid form that, when contacted with water, causes the matrix to dissolve or disperse into the aqueous locus. A solid matrix can take virtually any solid form. The matrix can be a uniform solid or an irregular or amorphous solid. Regular solids include cubes, spheres, egg shapes, spheroids, pyramids, cylinders, and other such regular geometric shapes. Alternatively, the matrix can be generally amorphous and can take an undefined general shape.

The matrix typically comprises a water soluble or dispersible material. Such materials can be organic or inorganic. Soluble organic material can include the above-mentioned water-soluble polymeric materials. The dispersible materials can comprise such materials as perlite, cellulosic materials derived from sawdust, recycled paper, etc. The only requirement in the matrix control unit is that the matrix must be substantially dissolved or dispersed within approximately 48 hours after contact with water in the treatment locus. The matrix can be made typically by forming a solid unit comprising the soluble or dispersible matrix element, the active control agent and the particulate material. The matrix can have a volume that ranges from about 50 mL to as large as 2 Liters. Commonly, the enclosed volume of the envelope will range from about 200 mL to 600 mL.

Typically, the matrix contains about 30 to about 250 grams of the carrier or particulate. The particulate can either be a dense particulate or have a density less than water (typically less than 1 gram per cm⁻³). The matrix can contain about 0.3 to about 10 grams of diluent or absorbing powder and about 0.2 to about 6.5 grams of the control agent.

The preferred control unit for flying insects such as mosquitoes can be composed of up to four elements, including (1) S-Methoprene (or other mosquito control active ingredient) in an amount that provides effective mosquito control, for a desired control duration;

(2) a buoyant solid diluent filler, such as mineral perlite or wood sawdust which is selected of a wood density and particle size that floats initially upon contact with water, and disperses on the water surface away from the application loci, which particles thereafter saturate with water and sink, whereby all surfaces of each sawdust particle is in contact with water;

(3) an optimal absorbent such as an activated carbon in powder or fine granule form which serves as a controlled release means by adsorption of the active ingredient onto the activation sites within the carbon pores, and thereafter upon contact with water the solvent action of water slowly elutes the active ingredient (A.I.) off of the activate carbon and into solution; and

(4) an envelope containing each of the above ingredients, either in solid or sealed water soluble pouch form, such as using a water soluble or dispersible film polyvinyl alcohol pouch into which is loaded the blended composition of activated carbon loaded with mosquito controlling active ingredient and buoyant filler, the combination of which has been blended in a mixer to attach the A.I. loaded particles to the buoyant particles.

### DETAILED DESCRIPTION OF THE FIGURE

FIG. 1 is a plan view of the treatment unit of the invention. In FIG. 1, treatment unit 10 comprises a soluble polymeric envelope 11 that contains the treatment material 12. The treatment material 12 typically comprises an absorbent particulate such as perlite or other absorbent material containing the treatment agent absorbed into the carrier. The treatment unit contains sufficient treating agent to obtain either a short term or residual control. The amounts of treating agent can be modified in the envelope by either adding additional amounts of treatment agent to the carrier or by using additional carrier and treatment agent. In a preferred mode, the treatment envelope is 3 to 8 inches in length, 2 to 6 inches in width and has a depth of ½ to 1.5 inches.

### EXEMPLARY SECTION

### Example 1

A 42 gm (1.8%) S-Methoprene control unit, using mineral perlite buoyant agent, designed to treat ⅛ acre (506 ml or 5,445 square feet) for five to fifteen days was prepared using the following formulation recipe:

| Ingredient | % W/W | Weight (lbs.) |
|---|---|---|
| 40% S-Methoprene Wettable Powder | 4.5 | 4.50 (2.05 kG) |
| Perlite | 91.5 | 91.50 |
| Polyvinyl Alcohol (PVA) Film Envelope | 4.0 | 4.00 |

Place 91.5 pounds of mineral perlite (less than 14 mesh) in an appropriately sized ribbon blender. Next, 4.5 pounds of the S-Methoprene 40% Wettable Powder was added to the mixer. The mixer was then closed, turned on and blended for 10 minutes. The wettable powder-perlite blend was then discharged and packaged in a fiberboard drum. The blend was loaded into the hopper of an automatic PVA pouch loading machine, and the machine was calibrated to load 40.3 gms of the wettable powder-perlite blend in 1.7 gm PVA film pouches to make 42 gram pouches. Once loaded, the pouches were sealed in plastic containers or Mylar packaging to protect them from humidity until use.

### Example 2

A 42 gm 3.6% S-Methoprene control unit, using mineral perlite buoyant agent, designed to treat ¼ acre (1013 m² or 11,090 square feet) for five to fifteen days was prepared using the following formulation recipe:

| Ingredient | % W/W | Weight (lbs.) |
|---|---|---|
| 40% S-Methoprene Wettable Powder | 9.0 | 9.0 (4.1 kG) |
| Perlite | 86.5 | 86.5 |
| Polypropylene Glycol | 0.5 | 0.5 |
| Polyvinyl Alcohol (PVA) Film | 4.0 | 4.0 |

Place 86.5 pounds of perlite (less than 14 mesh) in an appropriately sized ribbon blender. Next, 9.0 pounds of the S-Methoprene 40% Wettable Powder was added to the mixer. The mixer was then closed, turned on and blended for 5 minutes. Then, 0.5 pound of polypropylene glycol was sprayed on the blending ingredients to attach the WP to the perlite particles, and blended for 5 minutes. The wettable powder-perlite blend was then discharged and packaged in a fiberboard drum. The blend was loaded into the hopper of an automatic PVA pouch loading machine, and the machine was calibrated to load 40.3 gms of the wettable powder-perlite blend in 1.7 gm PVA film pouches to make 42 gram pouches. Once loaded, the pouches were sealed in plastic containers or Mylar packaging to protect them from humidity until use.

### Example 3

An 84 gm 3.6% S-Methoprene control unit, using mineral perlite buoyant agent, designed to treat 1 acre (2025 m² or 21,780 square feet) for five to fifteen days was prepared using the following formulation recipe:

| Ingredient | % W/W | Weight (lbs.) |
|---|---|---|
| 40% S-Methoprene Wettable Powder | 9.0 | 18.0 (8.16 kG) |
| Perlite | 86.0 | 172.0 |
| Polypropylene Glycol | 1.0 | 2.0 |
| Polyvinyl Alcohol (PVA) Film | 4.0 | 8.0 |

First, 173 pounds of Perlite (less than 14 mesh) was placed in an appropriately sized ribbon blender. Next, 18.0 pounds of the S-Methoprene 40% Wettable Powder was added to the mixer. The mixer was then closed, turned on and blended for 5 minutes. Then, 2.0 pounds of polypropylene glycol was sprayed on the blending ingredients to attach the Wettable Powder to the perlite particles, and the combination was blended for 5 minutes. The wettable powder-perlite blend was then discharged and packaged in a fiberboard drum. The blend was loaded into the hopper of an automatic polyvinyl alcohol pouch loading machine, and the machine was calibrated to load 80.6 gm of the wettable powder-perlite blend in 3.4 gm polyvinyl alcohol film pouches to make 84 gram pouches. Once loaded, the pouches were sealed in plastic containers or Mylar packaging to protect them from humidity until use.

### Example 4

A 84 gm 7.2% S-Methoprene control unit using mineral perlite buoyant agent, designed to treat 1 acre (4050 m² or 43,560 square feet) for five to fifteen days was prepared using the following formulation recipe:

| Ingredient | % W/W | Weight (lbs.) |
|---|---|---|
| 40% S-Methoprene Wettable Powder | 18.0 | 18.0 (8.16 kG) |
| Perlite | 75 | 75.0 |
| Polypropylene Glycol | 3.0 | 3.0 |
| Polyvinyl Alcohol (PVA) Film | 4.0 | 4.0 |

First, 75.0 pounds of Perlite (less than 14 mesh) was placed in an appropriately sized ribbon blender. Next, 18.0 pounds of the S-Methoprene 40% Wettable Powder was added to the mixer. The mixer was closed, turned on and blended for 5 minutes. Then, 3 pounds of polypropylene glycol was sprayed on the blending ingredients to attach the wettable powder to the perlite particles. The wettable powder-perlite blend was then mixed for 5 minutes, discharged and packaged in a fiberboard drum. The blend was then loaded into the hopper of an automatic polyvinyl alcohol pouch loading machine, and the machine was calibrated to load 80.6 gm of the wettable powder-sawdust blend in 3.4 gm pouches. Once loaded, the pouches were sealed into plastic containers or Mylar packaging to protect it from humidity until use.

### Example 5

A 30 gm, 2.5% S-Methoprene control unit using liquid active ingredient and liquid carrier, designed to treat ⅛ acre (506 ml or 5,445 square feet) for five to fifteen days was prepared using the following formulation recipe:

| HIngredient | % W/W | Weight (lbs.) |
|---|---|---|
| 95% S-Methoprene Technical | 2.63 | 2.63 (1.19 kG) |
| Polypropylene Glycol | 90.70 | 90.70 |
| Polyvinyl Alcohol (PVA) Film | 6.67 | 6.67 |

First, 90.70 pounds of polypropylene glycol was placed in an appropriately sized mix tank. Next, 2.63 pounds of 95% S-Methoprene technical was added to the mixer. The mixer was then turned on and blended for 5 minutes. Then, the blend was loaded into the hopper of an automatic polyvinyl alcohol liquid pouch loading machine, and the machine was calibrated to load 28.0 gm of the S-Methoprene technical/polypropylene glycol liquid blend in each 2.0 gm polyvinyl alcohol film pouch to make 30 gram pouches. Once loaded, the pouches were sealed in plastic containers or Mylar packaging to protect them from humidity until use.

### Example 6

A 42 gm 1.8% S-Methoprene control unit with Wettable Powder and inert (weight contributing) ingredient, designed to treat ⅛ acre (506 m² or 5,445 square feet) for five to fifteen days was prepared using the following formulation recipe:

| Ingredient | % W/W | Weight (lbs.) |
|---|---|---|
| 40% S-Methoprene Wettable Powder | 4.50 | 4.50 (2.04 kG) |
| Diatomaceous Earth MP 77 | 91.50 | 91.50 |
| Polyvinyl Alcohol (PVA) Film | 4.00 | 4.00 |

Place 91.5 pounds of Eagle Pitcher Diatomaceous Earth MP-77 in an appropriately sized ribbon blender. Next, 4.5 pounds of the S-Methoprene 40% Wettable Powder was added to the mixer. The mixer was then closed, turned on and blended for 10 minutes. The wettable powder-sawdust blend was then discharged and packaged in a fiberboard drum. The blend was loaded into the hopper of an automatic polyvinyl alcohol pouch loading machine, and the machine was calibrated to load 40.5 gm of the Wettable Powder-sawdust blend in 1.7 gm polyvinyl alcohol film pouches to make 40.3 gram pouches. Once loaded, the pouches were sealed in plastic containers or Mylar packaging to protect them from humidity until use.

### Example 7

An example of S-Methoprene tech sprayed on sawdust with no activated carbon, in a PVA pouch. A 42 gm (1.8%) S-Methoprene control unit, using S-Methoprene technical, a wood sawdust buoyant agent, and PVA envelope, designed to treat ⅛ acre (506 meter square or 5,445 square feet) for five to ten days was prepared using the following formulation recipe.

| Ingredient | % W/W | Weight (lbs.) |
|---|---|---|
| S-Methoprene Technical 95% | 1.9 | 1.9 (0.86 kG) |
| White Pine Sawdust | 94.1 | 94.1 |
| Polyvinyl alcohol (PVA) Envelope | 4.0 | 4.0 |

Place 94.1 pounds of White Pine (less than 14 mesh) sawdust in an appropriately sized ribbon blender. Next, turn on mixer and spray 1.9 pounds of S-Methoprene Technical solution on the blending sawdust. Turn off the mixer and package in labeled fiberboard drum. Next, load blend into the hopper of an automatic PVA pouch loading machine, and calibrate the machine to load 40.3 grams of the S-Methoprene sawdust blend in 1.7 gm PVA film pouches to make 42 gm pouches. Once loaded, the pouch was sealed and placed into plastic containers or Mylar packaging to protect it from humidity until use.

### Example 8

An example of an S-Methoprene tech sprayed on sawdust with no activated carbon, in a solid matrix or block. A 42 gm (1.8%) S-Methoprene control unit, using S-Methoprene technical and a wood sawdust buoyant agent made in a molded solid block, designed to treat ⅛ acre (506 meter square or 5,445 square feet) for five to ten days was prepared using the following formulation recipe.

| Ingredient | % W/W | Weight (lbs.) |
|---|---|---|
| S-Methoprene Technical 95% | 1.9 | 1.9 (0.86 kG) |
| White Pine Sawdust | 94.1 | 94.1 |
| Technical Protein Colloid | 4.0 | 4.0 |

Place 94.1 pounds of White Pine (less than 14 mesh) sawdust in an appropriately sized ribbon blender. Then turn on mixer and spray 1.9 pounds of S-Methoprene Technical solution on the blending sawdust. Next, uniformly spray a 10% solution of Technical Protein Colloid dissolved in warm water on to the blending S-Methoprene sawdust. Then discharge the blend into a compression machine to form 42 gram blocks or barbeque briquette shaped units. Dry compressed units to 1% moisture and package in plastic containers or Mylar packaging to protect it from humidity until use.

### Example 9

A Solid block unit containing wettable powder S-methoprene. A 42 gm (1.8%) S-Methoprene compressed solid control unit, using a wood sawdust buoyant agent with glue was designed to treat ⅛ acre (506 meter square or 5,445 square feet) for five to fifteen days was prepared using the following formulation recipe.

| Ingredient | % W/W | Weight (lbs.) |
|---|---|---|
| 40% S-Methoprene Wettable Powder | 4.5 | 4.50 (2.04 kG) |
| White Pine Sawdust | 85.5 | 85.5 |
| HiPure Gelatin | 10.0 | 10.0 |

Place 85.5 pounds of White Pine (less than 14 mesh) sawdust in an appropriately sized ribbon blender. Next, add 4.5 pounds of S-Methoprene 40% Wettable powder to the mixer. The mixer was then closed, turned on and blended for 10 minutes. The Wettable powder-sawdust blend was then sprayed with HiPure liquid gelatin, and passed through a press to form blocks or barbeque shaped briquette units. Once formed, briquettes were dried to 1% moisture in a heated drying room, and packaged in a sealed container.

### Example 10

Control unit comprising commercial S-Methoprene granules in an envelope. A 294 gm 1.4% S-Methoprene control unit using a commercial S-Methoprene granule in a polyvinyl alcohol film pouch, designed to treat ⅛ acre (506 meter sq. or 5,445 sq. ft.) for five to fifteen days was prepared using the following recipe.

| Ingredient | % W/W | Weight (lbs.) |
|---|---|---|
| Altosid XRG 1.5% Granule | 96.6 | 483 (219 kG) |
| Polyvinyl Alcohol Envelope | 3.4 | 17 |

To load the PVA pouch, the Altosid XRG Granule was loaded into the hopper of an automatic Polyvinyl Alcohol film pouch loading machine and the machine was calibrated to load 284 gms of the granule in each 10 gm PVA pouch. Once the pouch was loaded it was sealed and placed into plastic containers or Mylar packaging to protect it from humidity until use.

### Example 11

Control unit comprising commercial commercial S-Methoprene pellets in an envelope. A 237 gm 4.10% S-Methoprene control unit using a commercial S-Methoprene gypsum pellet in a polyvinyl alcohol film pouch, designed to treat ⅛ acre (506 meter sq. or 5,445 sq. ft.) for thirty to forty days was prepared using the following recipe.

| Ingredient | % W/W | Weight (lbs.) |
|---|---|---|
| Altosid 4.25% Pellet | 96.6 | 483 (219 kG) |
| Polyvinyl Alcohol Envelope | 3.4 | 17 |

To load the PVA pouch, the Altosid Pellet was loaded into the hopper of an automatic Polyvinyl Alcohol film pouch loading machine and the machine was calibrated to load 227 gms of the pellet in each 10 gm PVA pouch. Once the pouch was loaded it was sealed and placed into plastic containers or Mylar packaging to protect it from humidity until use.

### Description of Invention Use in Mosquito Control

The control unit is used in field insect control as follows. Upon locating a field breeding locus of any size, an Inspector would inspect the site to determine if pestiferous insect larvae are present. If present, a decision would be made to treat the locus with a control unit material. The size of the locus would then be determined from a map or other measuring means such as a GPS. If the locus size were not on the site map, it would be determined by pacing the length and width of the locus, then multiplying the number of paces by the number of feet per pace, then multiplying the length and width to approximate the area in m² or ft² in the site. The Inspector would then consult the product label to determine the number of treatment units to apply based on the product label instructions and size of the site. Each unit having a predetermined amount of control agent required to treat a locus of a predetermined size for a predetermined duration. Once the number of units was determined, the Inspector would simply throw them into the locus at some arbitrary distance from the shoreline, record the treatment on field forms, and move on to the next mosquito breeding site.

This scenario contrasts with the normal procedure of determining the size of the site, consulting a product label, then measuring out the correct amount of liquid or granules. Protective equipment gloves, eye protection, would then be donned, liquid quantities would be measured, placed in a pump up sprayer, water added, the sprayer shaken, then be pumped up to build spraying pressure. Then boots would be put on, the sprayer slung on the back or over a shoulder, and the site would be walked through on approximate 12-15 foot interval swaths spraying to apply the liquid insecticide. If a granule, the process would be repeated and the granules spread by walking through the site on 15-20 foot interval cranking a rotary plate granule spreader. Returning to the truck the equipment would be secured again, boots removed, and treatment recorded.

Use of the control unit in field mosquito control activities provides significant time, equipment and labor saving advantages. The highest cost of mosquito control is personnel labor required to measure and apply liquid or granular mosquito control materials to each mosquito breeding site. Thus, treatment unit pouches provide the benefit of rapid treatment, enabling many more mosquito breeding sites to be controlled in a day, reducing manpower needs or enabling more sites to be controlled with existing staff resulting in better control. As no mechanical application equipment is required, expenses and maintenance costs are also reduced.

### Experimental Field Trials

### Applying S-Methoprene Treatment Unit to Single Point Within Field Sites

### Tests of the 1.8% S-Methoprene Unit

### Example 1

Post-Hatch Treatments in Standing Water Locus
Habitat: Irrigated pasture
Species: Ochlerotatus melanimon
Site Size: 0.29 acre
Treatment: Post-hatch on 2nds
Dosage: 1 unit per ¼ acre (1010 m²)
WaterDepth: 6″-18″
Elapsed Days: 10
Sample Size: 25
Mortality: 100%

### Pre-Hatch Treatments in Episodically Flooded Locus

### Example 2

Habitat: Irrigated pasture
Species: O. melanimon
Site Size: 0.07 acre (300 m²)
Treatment: Pre-hatch
Dosage: 1 unit per ⅛ acre
Water Depth: 6″-12″
Elapsed Days: 21
Sample Size: 25
Mortality: 76%

### Pre-Hatch Treatments in Episodically Flooded Locus

### Example 3

Habitat: Irrigated pasture
Species: O. melanimon
Site Size: 0.25 acre (1010 m²)
Treatment: Pre-hatch
Dosage: 1 unit per ¼ acre
Water Depth: 6″-12″
Elapsed Days: 19
Sample Size: 25
Mortality: 100%

### Pre-Hatch Treatments in Episodically Flooded Locus

### Example 4

Habitat: Irrigated pasture
Species: O. melanimon
Site Size: 0.25 acre (1010 m²)
Treatment: Pre-hatch
Dosage: 1 unit per ¼ acre
WaterDepth: 6″-12″
Elapsed Days: 10
Sample Size: 38
Mortality: 92%

### Pre-Hatch Treatments in Episodically Flooded Locus

### Example 5

Habitat: Irrigated pasture
Species: O. melanimon
Site Size: 0.7 acre (3000 m²)
Treatment: Pre-hatch
Dosage: 1 unit per ¼ acre
Water Depth: 6″-12″
Elapsed Days: 10
Sample Size: 113
Mortality: 99%

Remarks: Water flowed through site for 3 days.

The above specification, examples and data provide a complete description of the manufacture and method of use of the composition and embodiments of the invention. Since many embodiments of the invention can be made without departing from the spirit and scope of the invention, the invention resides in the claims hereinafter appended.

We claim:

1. A method of controlling aquatic insects in a treatment locus, the method comprises selecting a treatment locus, obtaining a measure of the surface area of the locus and distributing one or more insect control units per each 50 to 8000 m² of the locus surface to one or more defined locations, said unit comprising greater than about 0.25% of a control agent; wherein the locus is controlled by placing about 3 to 100 grams of a mosquito control agent per 8000 m² in the defined location.

2. The method of claim 1 wherein the locus is a permanent water site.

3. The method of claim 1 wherein the locus is episodically flooded.

4. The method of claim 1 wherein the treatment units are distributed uniformly across the locus, the locus comprising about 500 to 1000 m².

5. The method of claim 1 wherein the treatment units are distributed uniformly across the locus, the locus comprising about 1000 to 2000 m².

6. The method of claim 1 wherein the treatment units are distributed uniformly across the locus, the locus comprising about 2000 to 8000 m².

7. The method of claim 1 wherein the treatment units are initially placed at a defined location comprising an area of less than 50 m².

8. The method of claim 1 wherein the agent is a liquid agent within the unit.

9. The method of claim 1 wherein one control unit is used to obtain control of the locus.

10. The method of claim 1 wherein the pest is a mosquito pest.

11. The method of claim 1 wherein the control agent comprises S-methoprene and perlite.

12. The method of claim 1 wherein the locus is a natural or built locus selected from a pond, a swamp, a slough, a reservoir, a basin, or other still water locus.

13. An aquatic insect control unit comprising:
(a) an effective amount of a pesticide to treat an area of less than about 8000 m² in a treatment locus;
(b) a particulate carrier, the carrier comprising at least a portion of the pesticide; and
(c) an envelope containing the pesticide and carrier.

14. The control unit of claim 10 wherein the pesticide comprises isopropyl-(2E,4E,7S)-11-methoxy-3,7,11-trimethyl-2,4-dodecadienoate.

15. The control unit of claim 10 wherein the particulate carrier comprises perlite having a particle size less than 10 millimeters.

16. The control unit of claim 10 also comprising absorbent particulate.

17. The control unit of claim 16 wherein the particulate comprises a carbon particulate.

18. The control unit of claim 10 wherein the envelope comprises a water-soluble envelope.

19. The control unit of claim 14 wherein the envelope comprises polyvinyl alcohol envelope.

20. The control unit of claim 14 wherein the polyvinyl alcohol envelope comprises a partially hydrolyzed polyvinyl alcohol envelope.

21. The control unit of claim 10 wherein there are about 3 to about 100 grams of pesticide in a unit having a weight of 20 to 500 grams.

22. The control unit of claim 10 wherein there is about 18 to about 450 grams of the carrier particulate in a unit having a weight of 20 to 500 grams.

23. The control unit of claim 10 wherein there is about 0.3 to about 200 grams of the absorbent particle in a unit having a weight of 20 to 500 grams.

24. The control unit of claim 10 wherein the unit weighs at least about 25 grams, and the envelope comprises a soluble film having a film thickness of about 0.5 to 4.0 millimeters and an enclosed volume at least 30 mL.

25. An aquatic insect control unit comprising:
(a) an effective amount of a pesticide to treat an area of less than about 8000 m² in a treatment locus; and
(b) a particulate carrier, the carrier comprising at least a portion of the pesticide; the pesticide and carrier in the form of a solid matrix.

26. The control unit of claim 10 wherein the pesticide comprises isopropyl-(2E,4E,7S)-11-methoxy-3,7,11-trimethyl-2,4-dodecadienoate.

27. The control unit of claim 10 wherein the particulate carrier comprises perlite having a particle size less than 10 millimeters.

28. The control unit of claim 10 also comprising absorbent particulate.

29. The control unit of claim wherein the particulate comprises a carbon particulate.

30. The control unit of claim 10 wherein the matrix is formed with a water-soluble or water dispersible polymer.

31. The control unit of claim 14 wherein the polymer comprises a natural gum, protein colloid or water soluble adhesive.

32. The control unit of claim 14 wherein the polymer comprises polyvinyl alcohol envelope.

33. The control unit of claim 14 wherein the polyvinyl alcohol comprises a partially hydrolyzed polyvinyl alcohol.

34. The control unit of claim 10 wherein there are about 3 to about 100 grams of pesticide in a unit having a weight of 20 to 500 grams.

35. The control unit of claim 10 wherein there is about 18 to about 450 grams of the carrier particulate in a unit having a weight of 20 to 500 grams.

36. The control unit of claim 10 wherein there is about 0.3 to about 350 grams of the absorbent particle in a unit having a weight of 20 to 500 grams.

37. The control unit of claim 10 wherein the unit weighs at least about 25 grams envelope comprises a soluble film having a film thickness of about 0.5 to 4.0 millimeters and an enclosed volume at least 30 mL.
